(19) United States
(12) Patent Application Publication
(10) Pub. No.: US 2009/0081445 A1
(43) Pub. Date: Mar. 26, 2009

(54) Ceramic Solid Component, Ceramic Layer With High Porosity, Use of Said Layer, and a Component Comprising Said Layer

(76) Inventors: Stefan Lampenscherf, Poing (DE); Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/087,478

(22) PCT Filed: Dec. 28, 2006
(86) PCT No.: PCT/EP2006/070233

§ 371 Date: Jul. 8, 2008

(30) Foreign Application Priority Data
Jan. 9, 2006 (EP) 06000338.1

(51) Int. Cl. B32B 5/18

(52) U.S. Cl. 428/312.6

(57) ABSTRACT

Ceramic layers are often used for heat insulation in a layer system, and have a high porosity therefore, The inventive porous ceramic heat insulating layer has a particular pore size distribution such that it has a high expansion tolerance event at temperatures higher than 1200° C.

### CROSS REFERENCE TO RELATED APPLICATIONS

This application is the US National Stage of International Application No. PCT/EP2006/070233, filed Dec. 28, 2006 and claims the benefit thereof. The International Application claims the benefits of European application No. 06000338.1 filed Jan. 9, 2006, both of the applications are incorporated by reference herein in their entirety.

### FIELD OF INVENTION

The invention relates to a ceramic solid component, to a ceramic layer having a high porosity, to the use of this layer at very high temperatures and to a component having this layer.

### BACKGROUND OF THE INVENTION

Ceramic layers are often used as thermal barriers on components which would not be fit for use at high temperatures without a protective layer. These are, for example, turbine blades for gas turbines or steam turbines. In this case, a ceramic thermal barrier layer is applied onto a substrate with a metallic bonding layer.

Besides rod-shaped EB-PVD layers of zirconium oxide, plasma-sprayed ceramic layers are also known which have a porosity in order on the one hand to achieve a low thermal conductivity and on the other hand to ensure a high thermal shock resistance. Particularly in the case of coatings for the combustion chamber, a high porosity is used. Plastic particles are often added during the plasma spraying, which evaporate and thus produce a desired porosity in the layer.

The previously known ceramic porous layers, however, exhibit a low strain tolerance particularly in the case of large layer thicknesses.

### SUMMARY OF INVENTION

It is therefore an object of the invention to provide a ceramic solid component, a ceramic layer, a use of the layer and a component, which overcome the problems mentioned above.

The object is achieved by a ceramic solid component, a ceramic layer, by a use and by a component as claimed in the claims.

Further advantageous measures are listed in the dependent claims, and these may advantageously be combined with one another in any desired way.

### BRIEF DESCRIPTION OF THE DRAWINGS

The invention will be explained in more detail with the aid of the following drawings.

FIG. 1 shows a layer system,

FIG. 2 shows a micrograph of a ceramic layer according to the prior art,

FIG. 3 shows a micrograph of a ceramic layer according to the invention,

FIG. 4 shows a gas turbine,

FIG. 5 shows a perspective view of a turbine blade, and

FIG. 6 shows a perspective view of a combustion chamber.

### DETAILED DESCRIPTION OF INVENTION

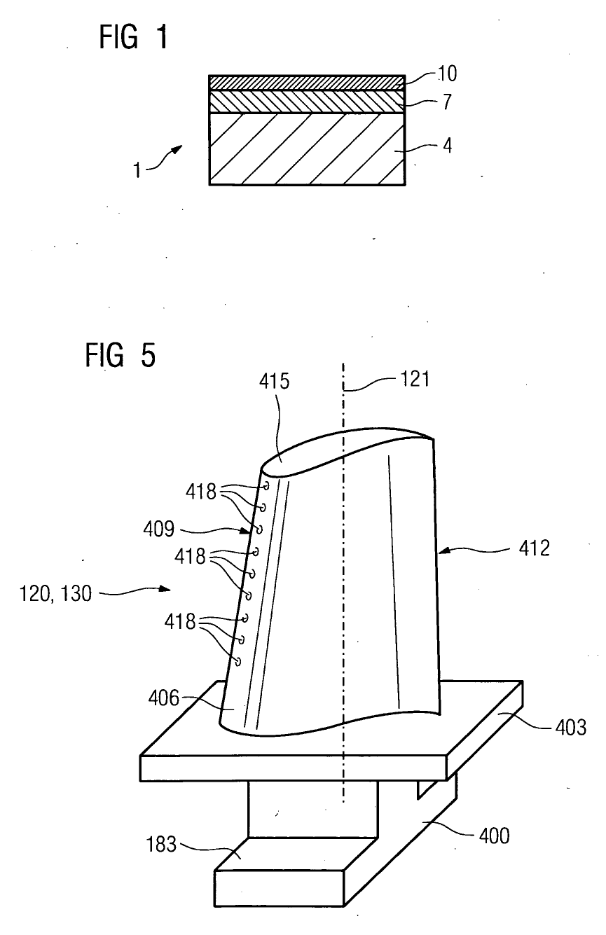

FIG. 1 shows a layer system 1 according to the invention.

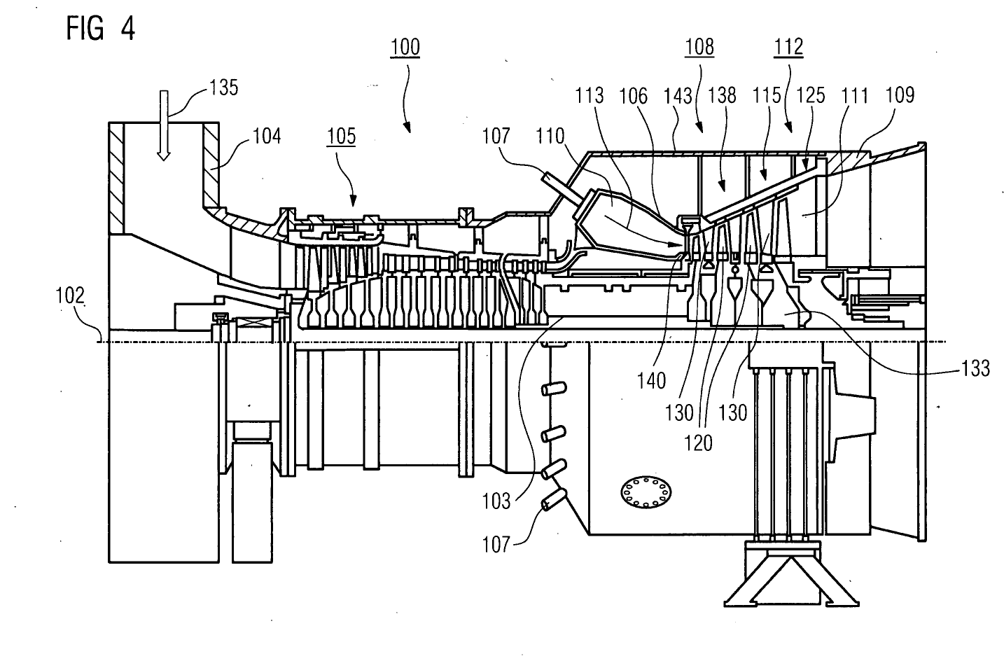

The layer system 1 consists of a substrate 4 which, in particular when used for high temperatures for example in gas turbines 100 (FIG. 4), consists of nickel- or cobalt-based superalloys. In the case of steam turbines, iron-based superalloys may also be used. On the substrate 4, there is preferably a metallic bonding layer 7 which is an alloy of the MCrAlX type.

On this metallic bonding layer 7 or on the substrate 4, there is a high-porosity ceramic layer 10 according to the invention.

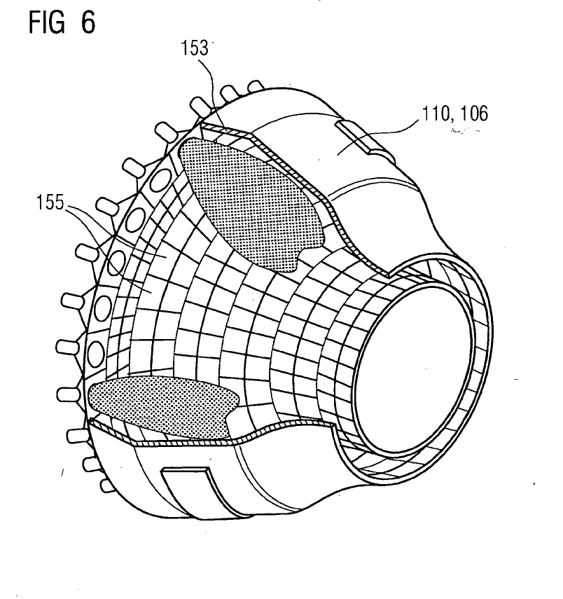

Particularly for very high temperatures, such as may arise for example for coatings inside the combustion chamber (FIGS. 6) (≧1100° C.), controlled adjustment of the porosity is necessary in order to achieve a sufficient strain tolerance.

FIG. 2 shows a micrograph of a ceramic thermal barrier layer with pores and their pore cross sections according to the prior art.

A pore in the ceramic layer is cut when producing the micrograph section and has a particular pore cross section in the section plane, which represents the area of the pore in the plane of the micrograph.

Any other micrograph gives similar values for the pore cross sections.

The porosity analysis for the micrograph according to the prior art does in fact yield pores in the range of 0 μm² to 3000 μm² and also pore cross sections in the range of 3000 μm² to 6000 μm², but no pore cross sections larger than this.

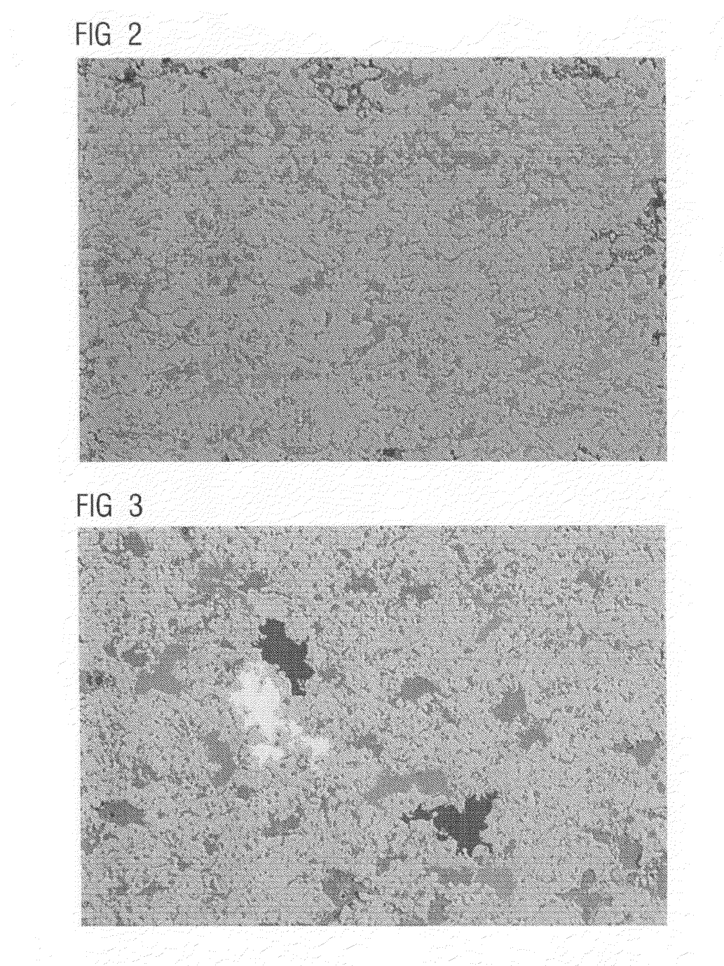

FIG. 3 shows a micrograph of a ceramic thermal barrier layer 10 according to the invention with pores and their pore cross sections.

The following table reveals a distribution of the pore cross sections.

| Pore Cross Section [μm²] | Number of Pores |
|---|---|
| 0 to 3000 | ~2200/mm² |
| 3000 to 6000 | ~8.5/mm² |
| 6000 to 9000 | ~2.8/mm² |
| 9000 to 12,000 | ~1.5/mm² |

The ceramic layer 10 according to the invention also comprises pore cross sections with values of between >6000 μm²-9000 μm² (FIG. 3).

Pore cross sections of >9000 μm²-12,000 μm² are preferably also present.

Pore cross sections of ≧12,000 μm² are preferably also present.

The high porosity is not achieved by a uniform enlargement of the pores according to the prior art, rather by the deliberate introduction of a few larger pores i.e. broadening of the pore cross section distribution, which then also leads to low hardness values for a ceramic layer.

The porosity is from 22 vol % to 28 vol %. Values around 24 vol % or 26 vol % are preferably used. The hardness of the layer measured by HV_{0.3} is about 630.

The layer thickness of the ceramic layer 10 lies between 200 μm and 2400 μm, in particular between 1000 μm and 1200 μm. The layer thickness may preferably also be more than 1500 μm.

The strain tolerance of this layer 10 according to the invention with a layer thickness of 1100 μm is almost 0.15% at 1300° C. Comparable standard layers have values <0.1%. There is therefore a significant increase in the strain tolerance for the layer 10 according to the invention at high temperatures. At low temperatures (around 1100° C.), the strain tolerance values of the standard layers and of the innovative layers are comparable.

The layer 10 is preferably produced by plasma spraying with plastic particles. Owing to the high proportion of plastic to be used, larger cavities are formed (percolation effect, i.e. the cavities overlap).

The microstructure of a solid component made of the porous ceramic corresponds to the microstructure of the layer.

Such components are preferably used as combustion chamber blocks for a combustion chamber 110.

FIG. 4 shows a gas turbine 100 by way of example in a partial longitudinal section.

The gas turbine 100 internally comprises a rotor 103, which will also be referred to as the turbine rotor, mounted so as to rotate about a rotation axis 102 and having a shaft 101.

Successively along the rotor 103, there are an intake manifold 104, a compressor 105, an e.g. toroidal combustion chamber 110, in particular a ring combustion chamber, having a plurality of burners 107 arranged coaxially, a turbine 108 and the exhaust manifold 109.

The ring combustion chamber 110 communicates with an e.g. annular hot gas channel 111. There, for example, four successively connected turbine stages 112 form the turbine 108.

Each turbine stage 112 is formed for example by two blade rings. As seen in the flow direction of a working medium 113, a guide vane row 115 is followed in the hot gas channel 111 by a row 125 formed by rotor blades 120.

The guide vanes 130 are fastened on an inner housing 138 of a stator 143 while the rotor blades 120 of a row 125 are fastened on the rotor 103, for example by means of a turbine disk 133.

Coupled to the rotor 103, there is a generator or a work engine (not shown).

During operation of the gas turbine 100, air 135 is taken in and compressed by the compressor 105 through the intake manifold 104. The compressed air provided at the turbine-side end of the compressor 105 is delivered to the burners 107 and mixed there with a fuel. The mixture is then burnt to form the working medium 113 in the combustion chamber 110. From there, the working medium 113 flows along the hot gas channel 111 past the guide vanes 130 and the rotor blades 120. At the rotor blades 120, the working medium 113 expands by imparting momentum, so that the rotor blades 120 drive the rotor 103 and the work engine coupled to it.

During operation of the gas turbine 100, the components exposed to the hot working medium 113 experience thermal loads. Apart from the heat shield elements lining the ring combustion chamber 110, the guide vanes 130 and rotor blades 120 of the first turbine stage 112, as seen in the flow direction of the working medium 113, are heated the most.

In order to withstand the temperatures prevailing there, they may be cooled by means of a coolant.

Substrates of the components may likewise comprise a directional structure, i.e. they are monocrystalline (SX structure) or comprise only longitudinally directed grains (DS structure).

Iron-, nickel- or cobalt-based superalloys are for example used as material for the components, in particular for the turbine blades 120, 130 and components of the combustion chamber 110.

Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The blades 120, 130 may likewise have coatings against corrosion (MCrAlX; M is at least one element from the group ion (Fe), cobalt (Co), nickel (Ni), X is an active element and stands for yttrium (Y) and/or silicon, scandium (Sc) and/or at least one rare earth element, or hafnium). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

On the MCrAlX layer, there may furthermore be a thermal barrier layer 10 according to the invention which consists for example of ZrO₂, Y₂O₃—ZrO₂, i.e. it is not stabilized or is partially or fully stabilized by yttrium oxide and/or calcium oxide and/or magnesium oxide.

Rod-shaped grains are produced in the thermal barrier layer by suitable coating methods, for example electron beam deposition (EB-PVD).

The guide vanes 130 comprise a guide vane root (not shown here) facing the inner housing 138 of the turbine 108, and a guide vane head lying opposite the guide vane root. The guide vane head faces the rotor 103 and is fixed on a fastening ring 140 of the stator 143.

FIG. 5 shows a perspective view of a rotor blade 120 or guide vane 130 of a turbomachine, which extends along a longitudinal axis 121.

The turbomachine may be a gas turbine of an aircraft or of a power plant for electricity generation, a steam turbine or a compressor.

Successively along the longitudinal axis 121, the blade 120, 130 comprises a fastening zone 400, a blade platform 403 adjacent thereto as well as a blade surface 406.

As a guide vane 130, the vane 130 may have a further platform (not shown) at its vane tip 415.

A blade root 183 which is used to fasten the rotor blades 120, 130 on a shaft or a disk (not shown) is formed in the fastening zone 400.

The blade root 183 is configured, for example, as a hammerhead. Other configurations as a firtree or dovetail root are possible.

The blade 120, 130 comprises a leading edge 409 and a trailing edge 412 for a medium which flows past the blade surface 406.

In conventional blades 120, 130, for example solid metallic materials, in particular superalloys, are used in all regions 400, 403, 406 of the blade 120, 130.

Such superalloys are known for example from EP 1 204 776 B1, EP 1 306 454, EP 1 319 729 A1, WO 99/67435 or WO 00/44949; with respect to the chemical composition of the alloy, these documents are part of the disclosure.

The blades 120, 130 may in this case be manufactured by a casting method, also by means of directional solidification, by a forging method, by a machining method or combinations thereof.

Workpieces with a monocrystalline structure or structures are used as components for machines which are exposed to heavy mechanical, thermal and/or chemical loads during operation.

Such monocrystalline workpieces are manufactured, for example, by directional solidification from the melts. These are casting methods in which the liquid metal alloy is solidified to form a monocrystalline structure, i.e. to form the monocrystalline workpiece, or is directionally solidified.

Dendritic crystals are in this case aligned along the heat flux and form either a rod crystalline grain structure (columnar, i.e. grains which extend over the entire length of the workpiece and in this case, according to general terminology usage, are referred to as directionally solidified) or a monocrystalline structure, i.e. the entire workpiece consists of a single crystal. It is necessary to avoid the transition to globulitic (polycrystalline) solidification in these methods, since nondirectional growth will necessarily form transverse and longitudinal grain boundaries which negate the beneficial properties of the directionally solidified or monocrystalline component.

When directionally solidified structures are referred to in general, this is intended to mean both single crystals which have no grain boundaries or at most small-angle grain boundaries, and also rod crystal structures which, although they do have grain boundaries extending in the longitudinal direction, do not have any transverse grain boundaries. These latter crystalline structures are also referred to as directionally solidified structures.

Such methods are known from U.S. Pat. No. 6,024,792 and EP 0 892 090 A1; with respect to the solidification method, these documents are part of the disclosure.

The blades 120, 130 may likewise have coatings against corrosion or oxidation, for example (MCrAlX; M is at least one element from the group ion (Fe), cobalt (Co), nickel (Ni), X is an active element and stands for yttrium (Y) and/or silicon and/or at least one rare earth element, or hafnium (Hf)). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

The density is preferably 95% of the theoretical density.

A protective aluminum oxide layer (TGO=thermally grown oxide layer) is formed on the MCrAlX layer (as an interlayer or as the outermost layer).

On the MCrAlX, there is furthermore a thermal barrier layer, which is preferably the outermost layer and consists for example of ZrO₂, Y₂O₃—ZrO₂, i.e. it is not stabilized or is partially or fully stabilized by yttrium oxide and/or calcium oxide and/or magnesium oxide.

The thermal barrier layer covers the entire MCrAlX layer.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CDV. The thermal barrier layer may comprise porous, micro- or macro-cracked grains for better shock resistance. The thermal barrier layer is thus preferably more porous than the MCrAlX layer.

Refurbishment means that components 120, 130 may need to have protective layers taken off (for example by sandblasting) after their use. Then the corrosion and/or oxidation layers or products are removed. Optionally, cracks in the component 120, 130 are also repaired. The component 120, 130 is then recoated and the component 120, 130 is used again.

The blade 120, 130 may be designed to be a hollow or solid. If the blade 120, 130 is intended to be cooled, it will be hollow and, optionally also comprise film cooling holes 418 (indicated by dashes).

FIG. 6 shows a combustion chamber 110 of a gas turbine.

The combustion chamber 110 is designed for example as a so-called ring combustion chamber in which a multiplicity of burners 107, which produce flames 156 and are arranged in the circumferential direction around a rotation axis 102, open into a common combustion chamber space 154. To this end, the combustion chamber 110 as a whole is designed as an annular structure which is positioned around the rotation axis 102.

In order to achieve a comparatively high efficiency, the combustion chamber 110 is designed for a relatively high temperature of the working medium M, i.e. about 1000° C. to 1600° C. In order to permit a comparatively long operating time even under these operating parameters which are unfavorable for the materials, the combustion chamber wall 153 is provided with an inner lining formed by heat shield elements 155 on its side facing the working medium M.

Each heat shield element 155 made of an alloy is equipped with a particularly heat-resistant protective layer (MCrAlX layer and/or ceramic coating) on the working medium side, or is made of refractory material (solid ceramic blocks).

These protective layers may be similar to the turbine blades, i.e. for example MCrAlX means: M is at least one element from the group iron (Fe), cobalt (Co), nickel (Ni), X is an active element and stands for yttrium (Y) and/or silicon and/or at least one rare earth element, or hafnium (Hf). Such alloys are known from EP 0 486 489 B1, EP 0 786 017 B1, EP 0 412 397 B1 or EP 1 306 454 A1 which, with respect to the chemical composition of the alloy, are intended to be part of this disclosure.

On the MCrAlX, there may furthermore be an e.g. ceramic thermal barrier layer which consists for example of ZrO₂, Y₂O₃—ZrO₂, i.e. it is not stabilized or is partially or fully stabilized by yttrium oxide and/or calcium oxide and/or magnesium oxide.

Rod-shaped grains are produced in the thermal barrier layer by suitable coating methods, for example electron beam deposition (EB-PVD).

Other coating methods may be envisaged, for example atmospheric plasma spraying (APS), LPPS, VPS or CDV. The thermal barrier layer may comprise porous, micro- or macro-cracked grains for better shock resistance.

Refurbishment means that heat shield elements 155 may need to have protective layers taken off (for example by sandblasting) after their use. The corrosion and/or oxidation layers or products are then removed. Optionally, cracks in the heat shield element 155 are also repaired. The heat shield elements 155 are then recoated and the heat shield elements 155 are used again.

Owing to the high temperatures inside the combustion chamber 110, a cooling system may also be provided for the heat shield elements 155 or for their retaining elements. The heat shield elements 155 are then hollow, for example, and optionally also have film cooling holes (not shown) opening into the combustion chamber space 154.

1.-14. (canceled)

15. A component having a ceramic layer, comprising:
a substrate; and
a ceramic layer arranged on the substrate where the ceramic layer comprises a plurality of pores having the following distribution of pore cross sections:
in the range 0 μm² to 3000 μm²:2000 to 2400 pores per μm²,
in particular ˜2200 pores per μm²,
in the range >3000 μm² to 6000 μm²:6 to 10 pores per μm²,
in particular ˜8.5 pores per μm²,
in the range >6000 μm² to 9000 μm²:2.2 to 3.2 pores per μm²,
in particular ˜2.8 pores per mm2,
in the range >9000 μm² to 12,000 μm²:1.0 to 2.2 pores per μm²,
in particular ˜1.5 pores per μm².

16. The component as claimed in claim 15, wherein the layer has
a porosity of from 22 vol % to 28 vol % and
a hardness of between 600 HV_{0.3} and 660 HV_{0.3}.

17. The component as claimed in claim 16, further comprising pores with pore cross sections of >12,000 μm².

18. The ceramic component as claimed in claim 17, wherein the layer porosity is 24 vol %.

19. The ceramic component as claimed in claim 17, wherein the layer porosity is 26 vol %.

20. The ceramic component as claimed in claim 19, wherein the layer thickness is between 200 μm and 2400 μm.

21. The ceramic component as claimed in claim 19, wherein the layer thickness is between 1000 μm and 1200 μm.

22. The ceramic component as claimed in claim 19, wherein the layer thickness is between 200 μm and 1000 μm.

23. The ceramic component as claimed in claim 19, wherein the layer thickness is more than 1500 μm.

24. The ceramic component as claimed in claim 19, wherein the component is operable at temperatures ≧1100° C.

25. The component as claimed in claim 24, wherein the component is a component of a steam turbine or gas turbine.

26. The component as claimed in claim 24, wherein the component is a combustion chamber element, a turbine blade or a housing part.

27. The component as claimed in claim 26, wherein the substrate is nickel-based.

28. The component as claimed in claim 26, wherein the substrate is cobalt-based.
